(19) United States
(12) Patent Application Publication
(10) Pub. No.: US 2006/0037652 A1
(43) Pub. Date: Feb. 23, 2006

(54) Reversing valve assembly with improved pilot valve mounting structure

(75) Inventors: Lawrence B. Hall, Plain City, OH (US); Jack A. Moreno, Delaware, OH (US)

Correspondence Address: REINHART BOERNER VAN DEUREN LTD., 483 NORTH MULFORD ROAD, SUITE 7, ROCKFORD, IL, 61107, US

(73) Assignee: Ranco Incorporated of Delaware, Wilmington, DE (US)

(21) Appl. No.: 10/924,178

(22) Filed: Aug. 23, 2004

(51) Int. Cl. F16K 11/06

(52) U.S. Cl. 137/625.43

(57) ABSTRACT

A pilot valve assembly includes a mounting bracket having at least three sides, including an anchor panel extending between first and second generally parallel leg panels. A four-sided mounting bracket, having a top leg panel connecting distal ends of the first and second leg panels is also disclosed. Disposed through the first leg panel and preferably through the second leg panel are respectively first and second apertures which define an axis line. A solenoid coil having a central bore is placed between the leg panels such that the central bore is aligned with the axis line. A pilot valve body is inserted through the first aperture and into the central bore such that an end of the pilot valve body is adjacent the second leg panel and secured thereto by various methods. The mounting bracket can be made from a single, integral blank.

### FIELD OF THE INVENTION

This invention pertains generally to reversing valves and more particularly to reversing valves having a solenoid-operated pilot valve for controlling operation of the reversing valve.

### BACKGROUND OF THE INVENTION

Reversing valve assemblies are typically used in fluid flow systems in which a fluid is directed to flow in various alternative loops or circuits. For instance, heat pumps are specialized refrigeration systems that can be selectively configured to operate in either of two different modes. In the first mode, known as the cooling mode, energy in the form of heat is removed from an “inside” environment and transferred to an “outside” environment. In the second mode, known as the heating mode, heat energy is transferred into the inside environment. To convey the heat energy, the heat pump system utilizes a compressor to circulate fluid refrigerant through a closed-circuit system that includes heat transfer coils located in each environment. In addition to circulating the refrigerant, the compressor is used to impart thermodynamic energy into the system.

To change the heat pump system between heating and cooling modes, the system includes the reversing valve assembly which can be selectively manipulated to alter the flow of refrigerant. The reversing valve assembly typically includes a reversing valve body having multiple ports that are interconnected with the heat transfer coils and the compressor. The reversing valve body also encloses a movable valve member that can be selectively placed between two different positions wherein the valve member directs refrigerant flow between different groupings of the ports. The valve member is moved in response to a change in actuating pressure that is supplied to the reversing valve body. Fluid refrigerant drawn off from the system is typically used as the source for the actuating pressure.

To control the change in the actuating pressure and thereby control the motion of the valve member, the reversing valve assembly typically includes a pilot valve assembly that is attached to the reversing valve body. The pilot valve assembly is an electrically-operated device that is in fluid communication with both the reversing valve body and the heat pump system to draw off refrigerant. To change the actuating pressure supplied to the reversing valve body, the pilot valve assembly includes an elongated pilot valve body having a plunger reciprocally movable therein. Different positions of the plunger cause the pilot valve assembly to alter the supply of the actuating pressure to the reversing valve body. The position of the plunger can be altered by activating a solenoid coil that surrounds a portion of the pilot valve body.

To attach the pilot valve assembly to the reversing valve body, often a mounting bracket is rigidly joined to the reversing valve body. The pilot valve body can be received in and extend from the mounting bracket. To secure the pilot valve body to the mounting bracket, the pilot valve body is often crimped in place or retained to the mounting bracket with a retainer clip. Crimping the pilot valve body greatly complicates its later removal from the reversing valve assembly for repair and replacement. Furthermore, the solenoid coil is typically provided with a distinct solenoid coil frame that must be separately installed to the mounting frame with another fastener. This prior art attachment method requires the use of separate mounting brackets and coil frames. Additionally, the solenoid coil frame is often installed over the extended portion of the pilot valve body in a cantilevered fashion. Cantilevered mounting of the solenoid coil subjects the pilot valve assembly to possible damage due to impact during handling and installation of the reversing valve assembly.

U.S. Pat. No. 4,712,582, assigned to Ranco Incorporated, herein incorporated in its entirety by reference, addresses the drawbacks of separately mounting the pilot valve body and the solenoid coil frame. U.S. Pat. No. 4,712,582 describes mounting an anchoring panel to the reversing valve body, then inserting the pilot valve body through the anchoring panel such that a portion of the valve projects away from the anchoring panel. A solenoid is next inserted over a projecting portion of the pilot valve body and placed adjacent to the anchoring panel. A retainer panel is detachably connected to the projecting portion of the pilot valve body to enclose the solenoid between the anchoring panel and retainer panel.

While this attachment arrangement provides significant benefits, utilizing both an anchor panel and a detachable retainer panel necessarily requires the manufacture of two separate parts, resulting in an increase to the cost of the reversing valve assembly. Additionally, the use of multiple parts complicates assembly of the reversing valve assembly, further increasing the cost. Also, to detachably connect the retainer panel, a threaded nut is fastened over the projecting portion of the pilot valve body thereby clamping the solenoid coil between the anchoring panel and retainer panel. Care must be taken during assembly to avoid over-tightening the nut and damaging the solenoid coil.

### BRIEF SUMMARY OF THE INVENTION

The present invention provides a reversing valve assembly having an improved mounting structure for attaching a pilot valve assembly. The reversing valve assembly includes a mounting bracket having at least three sides, including an anchor panel attached to the reversing valve body, a first leg panel extending perpendicularly from the anchor panel, and a second leg panel likewise extending perpendicularly from the anchor panel and parallel to the first leg panel. Disposed through the first leg panel is a first aperture while preferably disposed through the second leg panel is a second aperture. The first and second apertures are aligned with each other about a common axis line.

In some forms of the invention, the first and second leg panels of the mounting bracket define respective distal ends thereof, which are joined by a top panel. The first leg panel may be bowed inward toward the second leg panel, for applying a compressive holding force on the solenoid coil. The first leg panel may also be severed through the first aperture to form an upper portion of the first panel extending from the top panel, and a lower portion of the first panel extending from the anchor panel.

To activate the pilot valve assembly, an electrically actuated solenoid coil is provided. The solenoid coil has a central bore and is inserted in the three-sided mounting bracket between the first and second leg panels such that the central bore is aligned with the first and second apertures about the axis line. The pilot valve assembly includes an elongated pilot valve body that extends between a first end and an opposing second end. The pilot valve body is sized to engage in a sliding fit with the central bore. Disposed at various orientations into the pilot valve body proximate to the first end are a plurality of ports that are used to communicate with the reversing valve body and the refrigerant system.

To assemble the pilot valve assembly with the solenoid and the mounting bracket, the pilot valve body is inserted through the first aperture and received into the central bore, thereby aligning the pilot valve body with the axis line. When completely inserted, the second end of the pilot valve body abuts against the second leg panel while the first end extends from the first leg panel so that the ports are unobstructed. To hold the assembled pilot valve assembly, solenoid coil and mounting bracket together, the second end is secured to the second leg panel by way of, for example, a threaded fastener inserted through the second aperture. Securing the second end to the second leg panel also secures the solenoid coil to the mounting bracket. Advantageously, this manner of securing the components together does not compress the solenoid coil between the two parallel leg panels.

An advantage of the present invention is that the mounting bracket concurrently mounts both the pilot valve assembly and the solenoid coil to the reversing valve. Another advantage is that the mounting bracket, including the three panels, can be manufactured as a single piece. Another advantage is that the same act of securing the pilot valve body to the mounting bracket simultaneously secures the solenoid coil to the mounting bracket. These and other advantages and features of the present invention will be apparent from the detailed description and the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a front elevational view of a reversing valve assembly including a reversing valve and a pilot valve assembly mounted thereto.

FIG. 2 is a side elevational view of the reversing valve assembly of FIG. 1 taken along line 2-2.

FIG. 3 is a side elevational view of the reversing valve assembly of FIG. 1 taken along line 3-3.

FIG. 4 is a cross-sectional view of the pilot valve assembly including a solenoid coil, a mounting bracket, and a pilot valve assembly taken along line 4-4 of FIGS. 2 and 3.

FIG. 5 is a detailed view of an alternative embodiment taken about circle A of FIG. 4 wherein the pilot valve assembly is staked to the mounting bracket.

FIG. 6 is a detailed view of an alternative embodiment taken about circle A of FIG. 4 wherein the pilot valve assembly is riveted to the mounting bracket.

FIG. 7 is a detailed view of an alternative embodiment taken about circle A of FIG. 4 wherein the pilot valve assembly is retained to the mounting bracket with a retaining clip.

FIG. 8 is a detailed view of an alternative embodiment taken about circle A of FIG. 4 wherein the pilot valve assembly is welded to the mounting bracket.

FIG. 9 is a cross-sectional view, corresponding to FIG. 4, of an alternate embodiment of a valve assembly, which is substantially similar to the valve assembly shown in FIG. 4, except that the embodiment of FIG. 9 has a four-sided mounting bracket rather than the three-sided mounting bracket shown in FIG. 4.

FIG. 10 is a perspective view of the four-sided bracket of the embodiment shown in FIG. 9.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

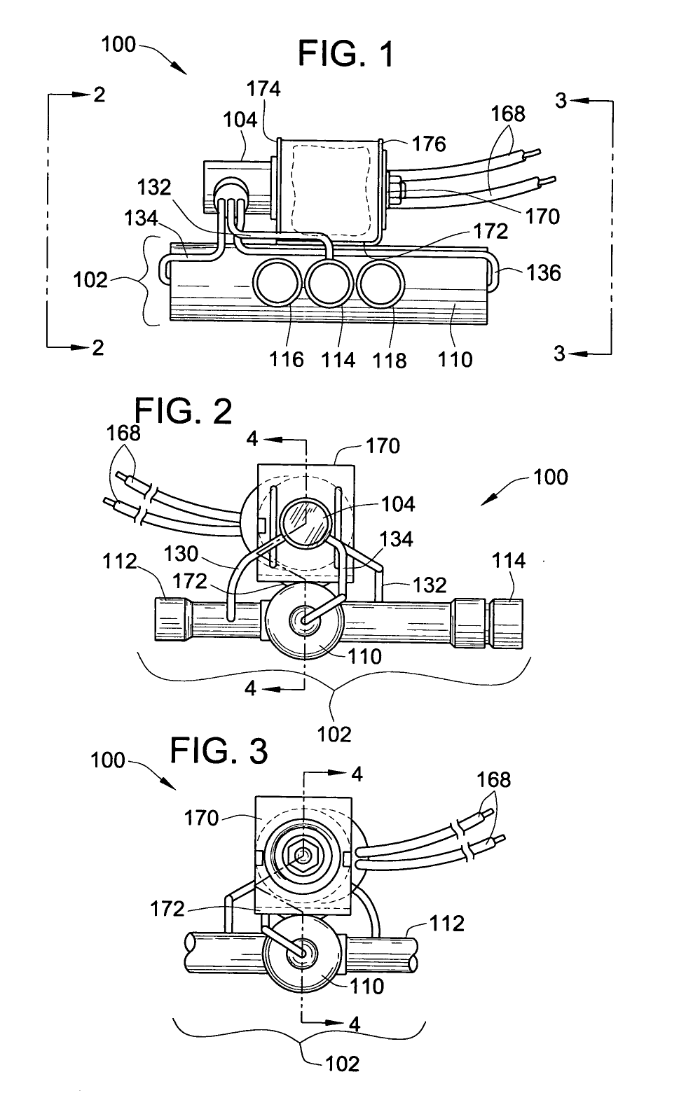

Now referring to the drawings, wherein like reference numbers refer to like elements, there is illustrated in FIGS. 1-3 an example of a reversing valve assembly 100 for use in a refrigeration system such as a heat pump. Heat pump systems typically include an “inside” heat exchanger located in an “inside” environment, an “outside” heat exchanger located in an outside environment, and a compressor for pressuring and pumping fluid refrigerant through the system. Heat pump systems are operable in two modes: a heating mode in which heat energy is transferred to the inside environment by the inside heat exchanger and a cooling mode in which heat energy is removed from the inside environment. To switch between the heating and cooling modes, the reversing valve assembly 100 is interconnected within the heat pump system and can selectively redirect the fluid refrigerant flow through the system.

The reversing valve assembly 100 includes a reversing valve 102 for selectively directing refrigerant through the heat pump system. The reversing valve 102 includes a tubular, elongated reversing valve body 110 from which extends at least four flow tubes 112, 114, 116, 118. The flow tubes can interconnect with refrigerant flow lines to establish fluid communication between the reversing valve 102 and the other components of the heat pump system. Typically, the first flow tube 112 communicates with the high pressure discharge of the compressor while the second flow tube 114 communicates with the low pressure inlet of the compressor. The third and fourth flow tubes communicate with the heat exchangers. To direct refrigerant flow between various flow tubes, there is enclosed in the reversing valve body 110 a reciprocally moving valve member (not shown). The position of the movable valve member within the reversing valve body 110 governs the direction of refrigerant flow through the heat pump system and thus determines whether the system is operating in the heating or cooling mode.

To control the position of the valve member, the reversing valve assembly 100 also includes a pilot valve assembly 104 mounted to the reversing valve 102. The pilot valve assembly 104 utilizes the pressurized refrigerant flowing in the heat pump system and converts that refrigerant pressure to an actuating pressure that physically moves the valve member. To accomplish this, in the illustrated embodiment, the pilot valve assembly 104 communicates by pipette 130 (see FIG. 2) to the first flow tube 112 to draw off high pressure refrigerant from the compressor discharge while also communicating by pipette 132 to the second flow tube 114 to draw off low pressure from the compressor inlet. These pressures are communicated by the pilot valve assembly 104 via pipettes 134, 136 (see FIG. 1) to the opposite ends of the reversing valve body 110 to create a pressure differential within the reversing valve body. Selective actuation of the pilot valve assembly 104 reverses the pressures being supplied to the opposing ends, thereby reversing the pressure differential and causing repositioning of the valve member within the reversing valve body 110.

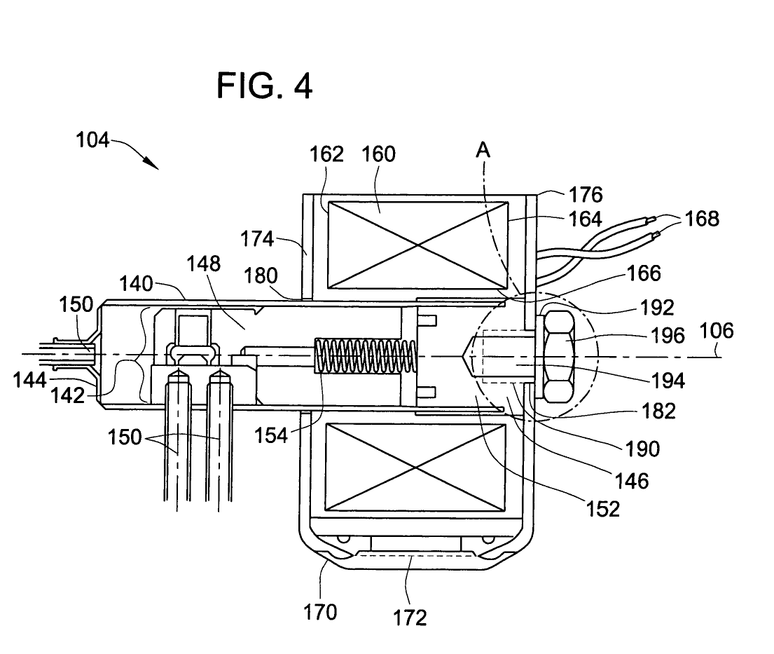

Referring to FIG. 4, the pilot valve assembly 104 includes an elongated pilot valve body 140 that encloses the pilot valve components 142 used to selectively direct the drawn system pressures to the reversing valve body. In the illustrated embodiment, the pilot valve body 140 is a cylindrical, tubular structure that extends between a first end 144 and an opposing second end 146. The pilot valve components 142 are movably situated toward the first end 144 where they can be moved by the action of a plunger 148 that is slidably received within the pilot valve body 140. Disposed at various orientations into the pilot valve body 140 proximate to the valve end 144 is a plurality of ports 150 that connect with the pipettes communicating with the reversing valve. Situated at and enclosing the second end 146 of the pilot valve body 140 is an end cap 152. To bias the plunger 148 in a first position, there is also enclosed within the pilot valve body a helical spring 154 extending between the end cap 152 and the plunger. p To activate the pilot valve assembly, there is also included an electrically-activated solenoid coil 160. The solenoid coil is formed from conductive wire that is wound to produce an electromagnetic effect when energized. The wound wire is preferably encapsulated in plastic or similar material and is shaped as a cylindrical drum having a first coil face 162, an opposing second coil face 164, and a cylindrical central bore 166 disposed therebetween. When the pilot valve assembly 104 is assembled to the solenoid coil 160, the pilot valve body 140 is received into the central bore 166 such that the first end 144 projects beyond the first coil face 162 and the solenoid coil surrounds the second end 146. The pilot valve body 140 and the central bore 166 are preferably sized to engage together in a sliding fit. As will be appreciated by those of skill in the art, when the solenoid coil 160 is energized, the plunger 148 is axially drawn toward the second end 146 thereby compressing the helical spring 154 against the end cap 152. To connect the solenoid coil 160 to a power source, two lead wires 168 are included.

To mount the pilot valve and solenoid coil to the reversing valve, a mounting bracket 170 is provided. The mounting bracket preferably has at least three sides, and is preferably manufactured from a ferrous metal or other similar magnetically permeable material. The intermediate side of the mounting bracket is defined by an anchor panel 172. Extending generally perpendicularly from an edge of the anchor panel 172 is a first leg panel 174 while extending generally perpendicularly from an opposite edge of the anchor panel is a second leg panel 176. Accordingly, the two leg panels 174, 176 are generally parallel to each other and are spaced apart from one another by the anchor panel 172.

Disposed through the first leg panel 174 is a first aperture 180 while preferably, but not necessarily, disposed through the second leg panel 176 is a second aperture 182. The first and second apertures 180, 182 are positioned within the leg panels so as to be aligned with one another and thereby define an axis line 106. Accordingly, the anchor panel 172 is offset below the axis line 106 while the first and second leg panels 174, 176 are generally perpendicular to the axis line. In the illustrated embodiment, the apertures 180, 182 are circular in shape, with the diameter of the second aperture being smaller than the diameter of the first aperture. Preferably, the diameter of the first aperture 180 is dimensioned to produce a sliding fit with the pilot valve body 140.

The mounting bracket 170 is formed as a single integral piece with the first and second leg panels 174, 176 permanently joined to the anchor panel 172. Each of the panels can have a generally rectangular, planar shape. Preferably, the mounting bracket including each of the panels and the apertures is formed from a common blank of material through a stamping and bending operation. Producing the mounting bracket as a single piece results in substantial savings in the cost of material and manufacturing.

Referring again to FIGS. 1-3, to attach the mounting bracket 170 to the reversing valve 102, the anchor panel 172 is joined to approximately the midpoint of the reversing valve body 110 with the leg panels 174, 176 extending away from the reversing valve body. Various joining methods can be used to accomplish this, including welding, soldering, and adhesive bonding.

As illustrated in FIG. 4, to assemble the solenoid coil 160 and mounting bracket 170 together, the solenoid coil 160 is first placed between the first and second leg panels 174, 176 such that the central bore 166 is aligned with the first and second apertures 180, 182. Accordingly, the central bore 166 is aligned with the axis line 166. The dimension of the anchor panel 172 between the first and second leg panels 174, 176 is approximately the same as the dimension of the solenoid coil 160 between the first coil face and the second coil face 162, 166. Accordingly, the first and second leg panels 174, 176 should respectively contact the first coil face 162 and the second coil face 164. Contacting the leg panels 174, 176 with the solenoid coil 160 helps guarantee a good magnetic coupling between the solenoid coil and the mounting bracket 170.

In an embodiment, to exert a compressive holding force upon the solenoid coil 160, the first and second leg panels 174, 176 converge slightly towards each other as they extend from the anchor panel 172. The slightly converging leg panels 174, 176, while still being generally parallel, act as a spring biasing against the respective first and second coil faces 162, 166. To avoid damaging the solenoid coil, the compressive force exerted should be the minimum necessary to hold the solenoid coil in place during assembly. Another advantage of converging the leg panels to exert a compressive force is that rattling of the solenoid coil between the leg panels during operation of the reversing valve is reduced or eliminated. A further advantage of converging the leg panels to exert a compressive force is a further improvement in magnetic coupling between the solenoid coil and the mounting bracket.

To add the pilot valve assembly 104 to the mounting bracket 170 and the solenoid coil 160, a portion of the pilot valve body 140 is inserted through the first aperture 180 and into the central bore 166. Because of the sliding fit between the pilot valve body 140, the first aperture 180, and the central bore 166, the cylindrical pilot valve body is aligned with the axis line 106. When completely inserted, the second end 146 of the pilot valve body 140 abuts against the second leg panel 176 adjacent the smaller second aperture 182. Additionally, the first end 144 of the pilot valve body 140 extends from the first leg panel 174 through the first aperture 180 so that the ports 150 are accessible.

To hold the pilot valve assembly 104 to the mounting bracket 170, the second end 146 is secured to the second leg panel 176 through the second aperture 182. As will be appreciated, because the pilot valve body 140 passes through the central bore 166, the act of securing the second end 146 to the second leg panel 176 likewise secures the solenoid coil 160 to the mounting bracket 170. Advantageously, the act of securing the second end 146 directly to the second leg panel 176 does not place the solenoid coil under compression between the first and second leg panels, thereby avoiding potential damage of the solenoid coil from over-compression. The pilot valve body can be secured to the second leg panel by any of a number of securing methods.

For example, referring to FIG. 4, the end cap 152 of the pilot valve body 140 can have a threaded hole 190 disposed into it from the second end 146. When the second end 146 is placed adjacent the second leg panel 176, a complementary-sized threaded shank 194 of a threaded fastener 192 can be inserted through the second aperture 182 and received into the threaded hole 190. Accordingly, the second leg panel 176 is thereby clamped between the second end 146 and the head portion 196 of the threaded fastener. One major advantage of using threaded fasteners 192 is that they are readily removable. Accordingly, the second end 146 can be unsecured from the second leg panel 176 to, for example, remove and replace the solenoid coil.

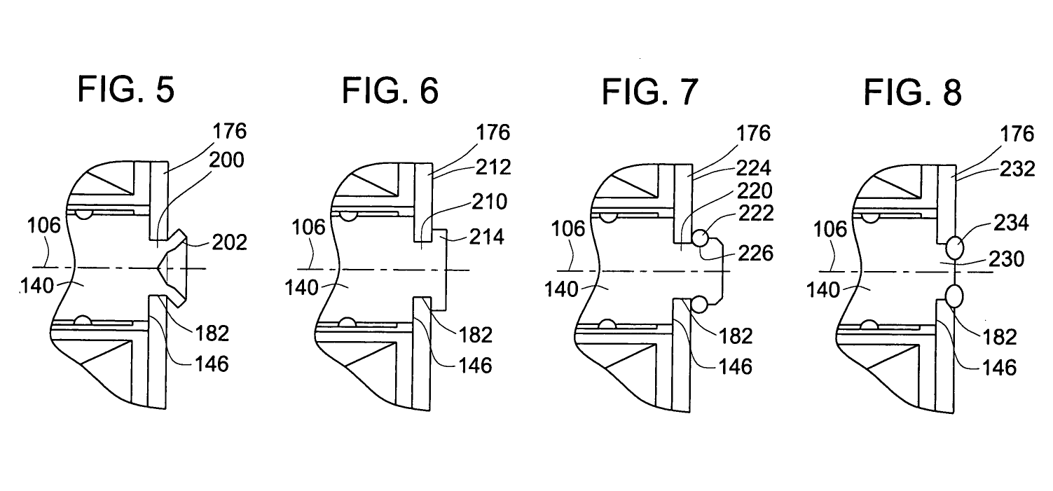

In other embodiments, the second end 146 can be secured to the second leg panel 176 in various other manners. For example, referring to FIG. 5, the pilot valve body 140 can include a mounting protrusion 200 extending from the second end 146 in the direction opposite the first end. The mounting protrusion 200 is preferably cylindrical in shape and aligned with the axis line 106. Additionally, the mounting protrusion 200 is dimensioned to slidably fit with and project through the second aperture 182 when the second end 146 is placed adjacent the second leg panel 176. The projecting portion of the mounting protrusion 200 is formed as a thin, cylindrical securing wall 202 that circles about the axis line 106. To secure the second end 146 and second leg panel 176 together, in a process well known to those of skill in the art, the securing wall 202 is staked to the second leg panel. Specifically, the securing wall 202 is physically deformed to fold adjacent the second leg panel 176 in the area around the second aperture 182. Accordingly, the second leg panel 176 is clamped between the second surface 146 and the securing wall 202.

Referring to FIG. 6, in another embodiment, the second end 146 can be riveted to the second leg panel 176. To accomplish this, the mounting protrusion 210 is cylindrical in shape and projects through the second aperture 182 and beyond an outermost surface 212 of the second leg panel 176 when the second end 146 is placed adjacent the second leg panel. In a process similar to staking, the mounting protrusion 210 is physically deformed to flatten into a shoulder 214 adjacent to the outermost surface 212 of second leg panel 176. Accordingly, the second leg panel 176 is clamped between the second surface 146 and the shoulder 214.

Referring to FIG. 7, in another embodiment, the second end 146 can be secured to the second leg panel 176 with a retaining clip 222. To accomplish this, the mounting protrusion 220 is again cylindrical in shape and projects through the second aperture 182 beyond the outermost surface 224 of the second leg panel 176. The retaining clip 222 is placed around the projecting mounting protrusion 220 so as to be generally adjacent the outermost surface 224 of the second leg panel 176. Accordingly, the second leg panel 176 is clamped between the second end 146 and the retaining clip 222. An advantage of using retaining clips is that they can be readily removed without damaging the mounting protrusion, thereby enabling the second end 146 to be unsecured from the second leg panel 176 to, for example, remove and repair the pilot valve body and solenoid coil. Preferably, to facilitate the clamping action and placement of the retaining clip 222, the mounting protrusion includes an appropriately located circumferential groove 226.

Referring to FIG. 8, in another embodiment, the second end 146 can be welded to the second leg panel 176. To accomplish this, the mounting protrusion 230 is slidably received into the second aperture 182 and projects coplanar to the outermost surface 232 of the second leg panel 176. Then, in a process known to those of skill in the art, a filler material is applied to and molten into a bead 234 at the junction between the mounting protrusion 230 and second leg panel 176. A gas burning flame or an electric arc can be used to melt the filler material. Once the bead 234 cools, it forms a rigid connection between the mounting protrusion 230 and the second leg panel 176 thereby securing the second end. Alternatively, the mounting protrusion 200 and the second leg panel 176 can be directly welded to each other in the absence of a filler material.

In the embodiment in which the second leg panel does not include the second aperture, the second end of the valve body can be secured directly to the second leg panel by, for example, adhesive bonding.

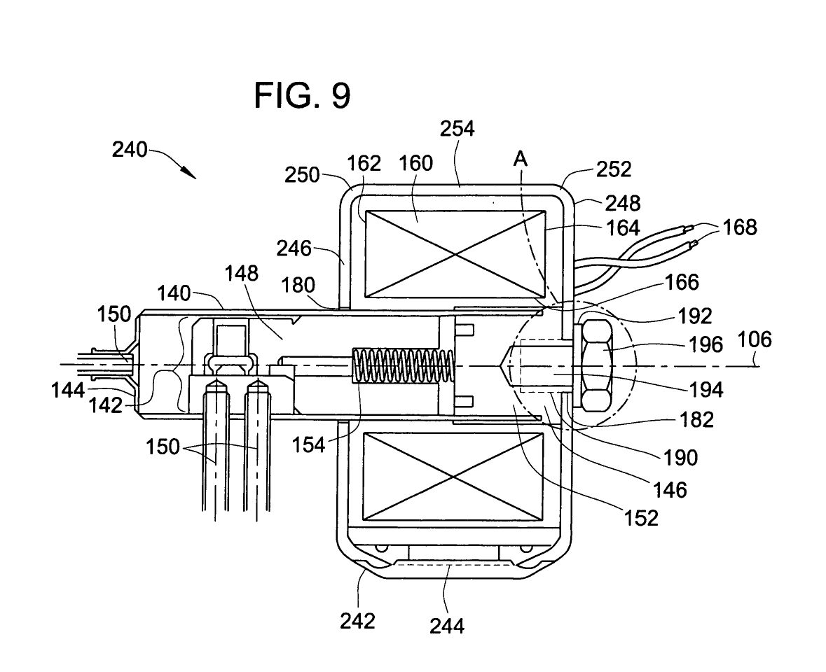

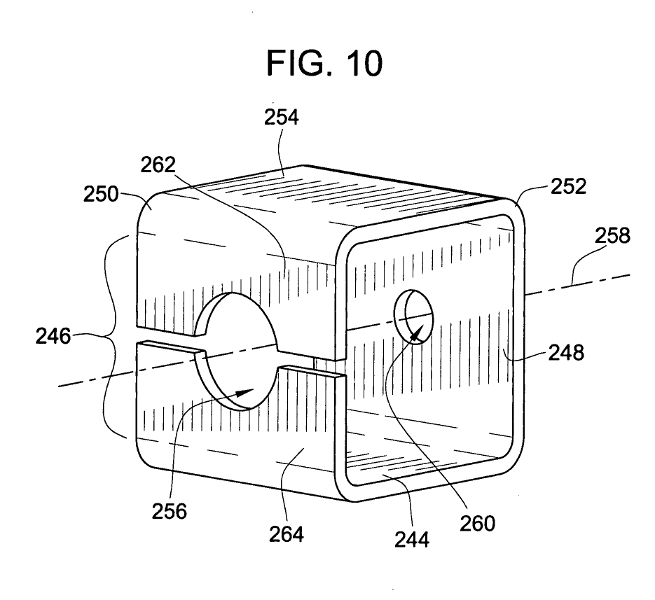

FIGS. 9 and 10 show an exemplary embodiment of the invention in the form of a valve assembly 240, that is generally identical to the valve assembly 104 described above in relation to FIG. 4, except that embodiment shown in FIGS. 9 and 10 has a four-sided mounting bracket 242, instead of the three-sided mounting bracket 170 shown in the embodiment of FIG. 4.

The four-sided mounting bracket 242 in the exemplary embodiment shown in FIGS. 9 and 10 includes an anchor panel 244, a first leg panel 246, a second leg panel 248, and a top panel 254. The first and second leg panels 246, 248 extend generally perpendicularly from the anchor panel 244, and defining respective distal ends 250, 252, or comers, thereof. The second leg panel 248 extends generally parallel to the first leg panel 246, with the top panel 254 connecting the distal ends 250, 252 of the first and second leg panels 246, 248.

The first leg panel 246 includes a first aperture 256, corresponding to the first aperture 180 of the embodiment shown in FIG. 4, and defining an axis line 258 extending through the mounting bracket 242 in the same manner as the axis line 106 extends through the embodiment described above in relation to FIG. 4, so that a solenoid coil 160 and a valve member 140 can be installed in the four-sided mounting bracket 242 in the same manner as described above in relation to the embodiment shown in FIG. 4. The second leg panel 248 of the four-sided mounting bracket 242 may also include a second aperture 260, corresponding to the second aperture 182 of the embodiment shown in FIG. 4, disposed about the axis line 258 to allow any use of any of the attachment methods described above in relation to FIGS. 1-8 for securing the second end 146 of the pilot valve to the second leg panel 248.

As best seen in FIG. 10, the first leg panel 246 of the four-sided mounting bracket 242 is severed from sided-to-side through the first aperture 256 to form an upper portion 262 of the first leg panel 246 extending from the top panel 254, and a lower portion 264 of the first leg panel 246 extending from the anchor panel 244. The first leg panel 246 is also bowed inward slightly (not shown) toward the second leg panel 248, so that the upper and lower portions 262, 264 can apply a compressive holding force on the solenoid coil 160. Having one of the four sides of the four-sided bracket 242 severed from side-to side also allows the mounting bracket 242 to be formed from a continuous -blank of sheet metal.

Hence, the present invention provides a novel mounting structure for mounting a pilot valve assembly and a solenoid coil to a flow reversing valve. The mounting structure includes a mounting bracket having at least three sides that can be manufactured as a single piece. Disposed through first and second generally parallel leg panels that correspond to two opposing sides of the mounting bracket are aligned first and second apertures. A solenoid coil for activating the pilot valve assembly is placed between the opposing leg panels such that the central bore of the solenoid coil aligns with the apertures about a common axis line. The pilot valve assembly includes an elongated valve body that is sized to be slidably received in the central bore. When assembled together, an end of the pilot valve body abuts against one of the opposing leg panels while a portion of the pilot valve body extends through the respective aperture of the other leg panel. To hold the pilot valve, solenoid coil, and mounting bracket together, the end of the pilot valve abutting the leg panel of the mounting bracket is secured thereto.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A reversing valve assembly comprising:
a reversing valve for reversing fluid flow in a refrigerant system, the reversing valve being actuated in response to a change in actuating pressure;
a mounting bracket including a anchor panel attached to the reversing valve, a first leg panel extending generally perpendicular from the anchor panel, and a second leg panel extending generally perpendicular from the anchor panel, the first and second leg panels including respectively a first and second aperture, the first and second apertures aligned about an axis line;
a solenoid coil including a central bore, the solenoid coil received between the first and second leg panels such that the central bore is aligned with the axis line; and
a pilot valve for supplying actuating pressure to the reversing valve, the pilot valve including an elongated valve body having a first end and an opposing second end, the pilot valve body being received in the central bore and extending along the axis line such that the first end extends from the first aperture and the second end abuts against and is secured to the second leg panel.

2. The reversing valve assembly of claim 1, further comprising a threaded fastener, wherein the second end includes a threaded hole axially disposed therein, and the threaded fastener is inserted through the second aperture and received in the threaded hole to secure the second end to the second leg.

3. The reversing valve assembly of claim 1, wherein the second end includes a mounting protrusion, the mounting protrusion projecting through the second aperture.

4. The reversing valve assembly of claim 3, wherein the mounting protrusion includes a securing wall staked adjacent to the second leg to secure the second end to the second leg.

5. The reversing valve assembly of claim 3, wherein the mounting protrusion is riveted into a shoulder adjacent the second leg to secure the second end to the second leg.

6. The reversing valve assembly of claim 3, further comprising a retaining clip, wherein the retaining clip is place around the mounting protrusion to secure the second end to the second leg.

7. The reversing valve assembly of claim 6, wherein the retaining clip is adjacent the second leg.

8. The reversing valve assembly of claim 6, wherein the mounting protrusion includes a groove for receiving the retaining clip.

9. The reversing valve assembly of claim 1, wherein the second end includes a mounting protrusion extending in a sliding fit into the second aperture, the mounting protrusion and the second leg being welded together at their juncture.

10. The reversing valve assembly of claim 9, wherein the mounting protrusion and the second leg are welded together at their junction with a bead of filler material.

11. The reversing valve assembly of claim 1, wherein the first and second legs converge slightly together to exert a compressive force on the solenoid coil.

12. The reversing valve assembly of claim 1, wherein the mounting bracket is formed from a continuous blank of sheet metal.

13. The reversing valve assembly of claim 1, wherein the first and second aperture are generally circular, and the first aperture is larger in diameter than the second aperture.

14. The reversing valve assembly of claim 1, where the first and second leg panels of the mounting bracket define respective distal ends thereof, and the mounting bracket further includes a top panel connecting the distal ends of the first and second leg panels.

15. The reversing valve assembly of claim 14, wherein the first leg panel is bowed inward toward the second leg panel, for applying a compressive holding force on the solenoid coil.

16. The reversing valve of assembly of claim 15, wherein the first leg panel is severed through the first aperture to form an upper portion of the first panel extending from the top panel, and a lower portion of the first panel extending from the anchor panel.

17. The reversing valve assembly of claim 16, wherein the mounting bracket is formed from a continuous blank of sheet metal.

18. The reversing valve of assembly of claim 14, wherein the first leg panel is severed through the first aperture to form an upper portion of the first panel extending from the top panel, and a lower portion of the first panel extending from the anchor panel.

19. The reversing valve assembly of claim 18, wherein at least one of the upper and/or lower portions of the first leg panel is bowed inward toward the second leg panel, for applying a compressive holding force on the solenoid coil.

20. The reversing valve assembly of claim 19, wherein the mounting bracket is formed from a continuous blank of sheet metal.

21. A solenoid operated valve assembly comprising:
a mounting bracket having at least three sides including an anchor panel, a first leg panel extending generally perpendicular from the anchor panel, and a second leg panel extending generally perpendicular from the anchor panel and generally parallel to the first leg panel, the first leg including a first aperture, the first aperture defining an axis line;
a solenoid coil including a central bore, the solenoid coil placed between the first and second legs such that the central bore is aligned with the axis line;
a valve member including an elongated valve body having a first end and an opposing second end, the valve body generally aligned with the axis line and received in the central bore such that the first end extends from the first aperture and the second end abuts the second leg and is secured thereto.

22. The valve assembly of claim 21, wherein the second leg includes a respective second aperture, the second aperture aligned with the axis line and with the first aperture.

23. The valve assembly of claim 22, further comprising a threaded fastener, wherein the second end includes a threaded hole axially disposed therein, and the threaded fastener is inserted through the second aperture and received in the threaded hole to secure the second end to the second leg.

24. The valve assembly of claim 21, wherein the mounting bracket is formed from a continuous blank of sheet metal.

25. The reversing valve assembly of claim 21, where the first and second leg panels of the mounting bracket define respective distal ends thereof, and the mounting bracket further includes a top panel connecting the distal ends of the first and second leg panels.

26. The reversing valve assembly of claim 25, wherein the first leg panel is bowed inward toward the second leg panel, for applying a compressive holding force on the solenoid coil.

27. The reversing valve of assembly of claim 26, wherein the first leg panel is severed through the first aperture to form an upper portion of the first panel extending from the top panel, and a lower portion of the first panel extending from the anchor panel.

28. The reversing valve assembly of claim 27, wherein the mounting bracket is formed from a continuous blank of sheet metal.

29. The reversing valve of assembly of claim 28, wherein the first leg panel is severed through the first aperture to form an upper portion of the first panel extending from the top panel, and a lower portion of the first panel extending from the anchor panel.

30. The reversing valve assembly of claim 29, wherein at least one of the upper and/or lower portions of the first leg panel is bowed inward toward the second leg panel, for applying a compressive holding force on the solenoid coil.

31. The reversing valve assembly of claim 30, wherein the mounting bracket is formed from a continuous blank of sheet metal.

32. A valve assembly comprising:
a mounting bracket having four sides including an anchor panel, a first leg panel extending generally perpendicular from the anchor panel and defining a distal end thereof, a second leg panel extending generally perpendicular from the anchor panel and generally parallel to the first leg panel and defining a distal end thereof, and a top panel thereof connecting the distal ends of the first and second leg panels;
the first leg including a first aperture defining an axis line;
a solenoid coil including a central bore, the solenoid coil placed between the first and second legs such that the central bore is aligned with the axis line; and
a valve member including an elongated valve body having a first end and an opposing second end, the valve body generally aligned with the axis line and received in the central bore such that the first end extends from the first aperture and the second end abuts the second leg and is secured thereto.

33. The valve assembly of claim 32, wherein the first leg panel is bowed inward toward the second leg panel, for applying a compressive holding force on the solenoid coil.

34. The valve of assembly of claim 33, wherein the first leg panel is severed through the first aperture to form an upper portion of the first panel extending from the top panel, and a lower portion of the first panel extending from the anchor panel.

35. The valve assembly of claim 34, wherein the mounting bracket is formed from a continuous blank of sheet metal.

36. The valve assembly of claim 35, further comprising a threaded fastener, wherein the second end includes a threaded hole axially disposed therein, and the threaded fastener is inserted through the second aperture and received in the threaded hole to secure the second end to the second leg.

37. The valve assembly of claim 35, wherein the second end includes a mounting protrusion, the mounting protrusion projecting through the second aperture.

38. The valve assembly of claim 37, wherein the mounting protrusion includes a securing wall staked adjacent to the second leg to secure the second end to the second leg.

39. The valve assembly of claim 37, wherein the mounting protrusion is riveted into a shoulder adjacent the second leg to secure the second end to the second leg.

40. The valve assembly of claim 37, further comprising a retaining clip, wherein the retaining clip is place around the mounting protrusion to secure the second end to the second leg.

41. The valve assembly of claim 40, wherein the mounting protrusion includes a groove for receiving the retaining clip.

42. The valve assembly of claim 35, wherein the second end includes a mounting protrusion extending in a sliding ft into the second aperture, the mounting protrusion and the second leg being welded together at their juncture.
